(19) United States
(12) Patent Application Publication
(10) Pub. No.: US 2015/0363379 A1
(43) Pub. Date: Dec. 17, 2015

(54) INPUT SUPPORT SYSTEM, INPUT SUPPORT METHOD AND INPUT SUPPORT PROGRAM

(71) Applicant: NEC SOLUTION INNOVATORS, LTD., Tokyo (JP)

(72) Inventors: Yuzuru OKAJIMA, Tokyo (JP); Kosuke YAMAMOTO, Tokyo (JP)

(73) Assignee: NEC Solution Innovators, Ltd., Tokyo (JP)

(21) Appl. No.: 14/761,180

(22) PCT Filed: Sep. 5, 2013
(86) PCT No.: PCT/JP2013/005268

§ 371 Date: Jul. 15, 2015

(30) Foreign Application Priority Data
Jan. 22, 2013 (JP) 2013-009572

(51) Int. Cl. G06F 17/24

(52) U.S. Cl. CPC G06F 17/246

(57) ABSTRACT

An input support system includes: input relation log storage means for storing, as an input relation log, pieces of information input to multiple input boxes in the past in association with one another; input candidate group storage means for storing an input candidate for each type of information in association with an input candidate of each other type; and input type relation estimation means for estimating to which combination of type-specific fields, as fields for respective types stored in the input candidate group storage means, a relation of types of input information between respective input boxes included in the multiple input boxes corresponds, based on the input relation log stored in the input relation log storage means, and type-specific input candidates and a combination thereof stored in the input candidate group storage means.

### TECHNICAL FIELD

The present invention relates to an input support system, an input support method, and an input support program for supporting input to an input box by a user.

### BACKGROUND ART

When a user is required to enter information into a certain input box, there are various techniques for supporting input of the information.

Patent Literature (PTL) 1 discloses a technique in which, when a facility name is input in a text box, it is converted to an address and input.

PTL 2 discloses a technique for supporting input to an input form having multiple input items. An input support method described in PTL 2 analyzes a group of multiple input items included in the input form, manages input items associated with each other as one merged group, and stores past instances of input to these input items in units of merged groups. Then, when information is input to a certain input item, the input item and the input information are used as retrieval conditions to extract the input instances of all input items in the merged group in order to display the input instances of other input items thus obtained as input candidates for the other input items.

PTL 3 discloses a technique for dealing with a problem that the name of a field to which user information is input is not a common name among respective systems. In the technique described in PTL 3, standard attributes associated with a certain input field are identified from a correspondence relation between input data input to the input field in the past and the standard attribute values registered in connection with the user, and the standard attributes identified on the server side are managed in association with the name of the input field. This leads to reducing the burden of another user or the like to enter, into the input form, information from the next time on.

### CITATION LIST

Patent Literatures

PTL 1: Japanese Patent Application Laid-Open No. H11-248472

PTL 2: Japanese Patent Application Laid-Open No. 2008-181218

PTL 3: Japanese Patent Application Laid-Open No. 2005-165826

### SUMMARY OF INVENTION

### Technical Problem

In an input form displayed on a screen or the like, multiple input boxes may be provided, or an input box for further input of information associated with information input on another screen may be provided. In this case, there is often association between information input to a certain input box and information input to another input box, such as that both are information on persons or products.

In a case where input boxes have such an association between the pieces of input information, when information is input to one input box, the input information can be often used as a clue to predict information to be input to another input box.

As a technique associated with input support using such a relationship between input boxes, for example, there is the method described in PTL 1. However, in the method described in PTL 1, there is a need to specify a type of data that can be input to each input box in advance, and it is complicated to make such specification for all input boxes in advance. Further, it may be difficult to properly specify a fine granularity of information, a slight difference in description format such as to use Chinese numerals or not, and the like.

According to the method described in PTL 2, even if a type of data that can be input to each input box is not specified in advance, an input candidate to another input item can be displayed based on a relation between input boxes and information input in the past. However, in the method described in PTL 2, there is a problem that no input candidate to another input item cannot be obtained when there is no input of information identical or similar to the past input.

According to the method described in PTL 3, it is assumed that the input fields and the standard attributes are associated with each other from the past input by another user or the like. If such an association is made, even a user who uses the system for the first time can enter user information automatically in another input field from information for identifying the user such as a user ID. However, the method described in PTL 3 is a method for supporting form input from user information, which does not consider that the system is applied to input boxes to which various types of information can be input. For example, in the method described in PTL 3, the standard attributes to the input field are identified based on an input value for one user. Therefore, for example, when the input value overlaps any other attribute value, or when the input value does not match a registered value for an attribute, which would correspond under normal circumstances, due to a difference in description format from the input value, there is a problem that no attribute to be input cannot be identified.

Therefore, it is an object of the present invention to provide an input support system, an input support method, and an input support program capable of supporting a user to enter information into various input boxes without specifying, in advance, a type of data that can be input or when there is no input of information identical or similar in content to the past input.

### Solution to Problem

The input support system according to the present invention is an input support system for supporting input to multiple input boxes, including: input relation log storage means for storing, as an input relation log, pieces of information input to the multiple input boxes in the past in association with one another; input candidate group storage means for storing an input candidate for each type of information in association with an input candidate of each other type; and input type relation estimation means for estimating to which combination of type-specific fields, as fields for respective types stored in the input candidate group storage means, a relation of types of input information between respective input boxes included in the multiple input boxes corresponds, based on the input relation log stored in the input relation log storage means, and type-specific input candidates and a combination thereof stored in the input candidate group storage means.

The input support method according to the present invention is an input support method for supporting input to multiple input boxes, including: causing input relation log storage means to store, as an input relation log, pieces of information input to the multiple input boxes in the past in association with one another; causing input candidate group storage means to store an input candidate for each type of information in association with an input candidate of each other type; causing input type relation estimation means to estimate to which combination of type-specific fields, as fields for respective types stored in the input candidate group storage means, a relation of types of input information between respective input boxes included in the multiple input boxes corresponds, based on the input relation log stored in the input relation log storage means, and type-specific input candidates and a combination thereof stored in the input candidate group storage means; and causing error detection means or input information recommendation means to make an error determination of information input to the multiple input boxes or predict information to be input thereto based on the estimation result by the input type relation estimation means and type-specific input candidates and a combination thereof stored in the input candidate group storage means.

The input support program according to the present invention is an input support program applied to a computer accessible to input relation log storage means for storing pieces of information input in the past to multiple input boxes in association with one another, and input candidate group storage means for storing an input candidate for each type of information in association with an input candidate of each other type, characterized by causing the computer to execute a process of estimating to which combination of type-specific fields, as fields for respective types stored in the input candidate group storage means, a relation of types of input information between respective input boxes included in the multiple input boxes corresponds, based on the input relation log stored in the input relation log storage means, and type-specific input candidates and a combination thereof stored in the input candidate group storage means.

### Advantageous Effect of Invention

According to the present invention, a user can be supported to enter information to various input boxes without specifying, in advance, a type of data that can be input, or when there is no input of information identical or similar in content to the past input.

### BRIEF DESCRIPTION OF DRAWINGS

FIG. 1 It depicts a block diagram depicting a configuration example of an input support system of a first exemplary embodiment.

FIG. 2 It depicts an explanatory diagram depicting an example of an input relation log stored in input relation log storage means 101.

FIG. 3 It depicts an explanatory diagram depicting an example of input candidate groups stored in input candidate group storage means 102.

FIG. 4 It depicts an explanatory diagram depicting an example in which input type relation estimation means 103 estimates an input type relation between input boxes.

FIG. 5 It depicts a flowchart depicting an example of operation of the first exemplary embodiment.

FIG. 6 It depicts an explanatory diagram depicting another example of input candidate groups stored in the input candidate group storage means 102.

FIG. 7 It depicts an explanatory diagram depicting still another example of input candidate groups stored in the input candidate group storage means 102.

FIG. 8 It depicts an explanatory diagram depicting an example of an input relation log with information indicative of persons who entered data.

FIG. 9 It depicts a block diagram depicting a configuration example of an input support system of a second exemplary embodiment.

FIG. 10 It depicts a flowchart depicting an example of operation of the input support system of the second exemplary embodiment.

FIG. 11 It depicts an explanatory diagram depicting an example of error detection processing by error detection means 104.

FIG. 12 It depicts an explanatory diagram depicting another example of error detection processing by error detection means 104.

FIG. 13 It depicts a block diagram depicting a configuration example of an input support system of a third exemplary embodiment.

FIG. 14 It depicts a flowchart depicting an example of operation of the input support system of the third exemplary embodiment.

FIG. 15 It depicts an explanatory diagram depicting an example of prediction processing by input information recommendation means 105.

FIG. 16 It depicts an explanatory diagram depicting another example of prediction processing by the input information recommendation means 105.

FIG. 17 It depicts an explanatory diagram depicting an example of an input relation log.

FIG. 18 It depicts an explanatory diagram depicting still another example of prediction processing by the input information recommendation means 105.

### DESCRIPTION OF EMBODIMENTS

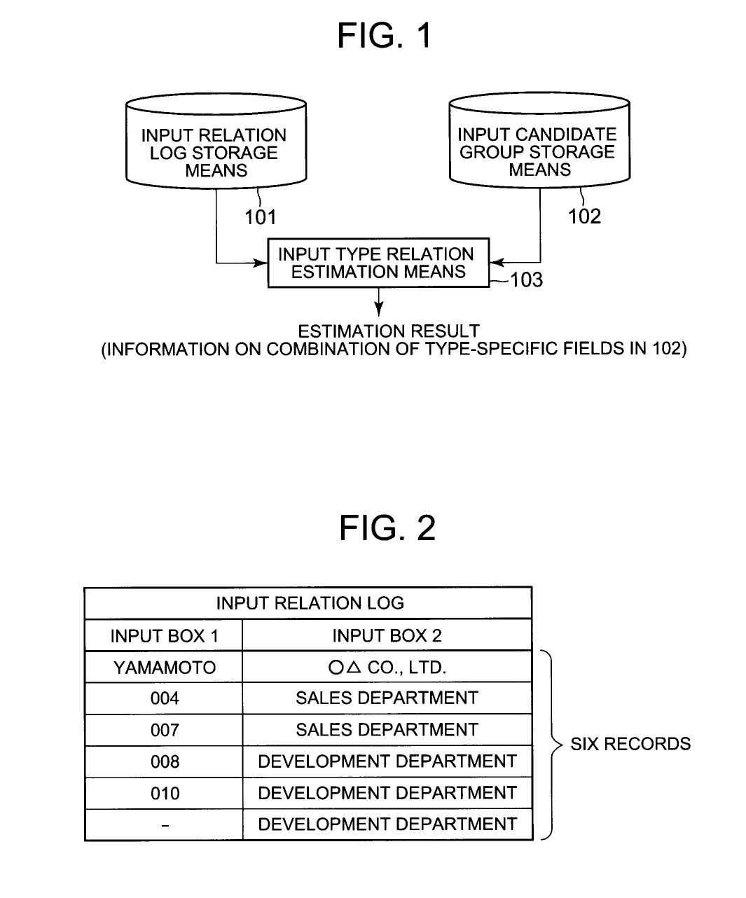

Exemplary embodiments of the present invention will be described below with reference to the accompanying drawings. FIG. 1 is a block diagram depicting a configuration example of an input support system of a first exemplary embodiment. The input support system depicted in FIG. 1 includes input relation log storage means 101, input candidate group storage means 102, and input type relation estimation means 103.

The input relation log storage means 101 merges information groups input to multiple input boxes in the past into one group and stores it as an input relation log. Here, the input relation log means a log of information indicative of an input relation as an input information relation between two or more input boxes. For example, the input relation log storage means 101 may group information input to specified multiple input boxes at the same timing to store it in a manner to make a correspondence to an input box as an input destination recognizable. Note that the input relation log storage means 101 may store information after converted to right information as a result of performing support of input to each input box.

Although it is assumed that the input boxes specified here are input boxes based on the assumption that pieces of input information are associated with one another, the input type relation estimation means 103 to be described later may determine the presence or absence of a relationship.

Note that information indicating which input box is associated with which input box may be held in the system in advance, or dynamically acquired by form analysis or the like. Further, in the case of a web page, input boxes in which pieces of information were input may be determined to be associated with each other from these pieces of information transmitted to a server at a time so as to determine that these input boxes are associated with each other.

FIG. 2 is an explanatory diagram depicting an example of an input relation log stored in the input relation log storage means 101. FIG. 2 depicts that information input to input box 1 in the past and information input to input box 2 in the past are stored as an input relation log in association with each other by their input timings. In the example depicted in FIG. 2, it is represented that pieces of information contained in one record were input at the same input timing. For example, FIG. 2 depicts that information as “Yamamoto” was input to the input box 1 and information as “∘Δ Co., Ltd.” was input to the input box 2 at the same timing as the first record of the input relation log. What is considered as the same input timing varies depending on the target form. For example, in a case where there are multiple input boxes in one form, pieces of information input in respective input boxes at the time when an event accompanied by a screen transition or a transmission event to the server occurs may be considered to have been input at the same input timing. In FIG. 2, “−” indicates a missing value. In other words, FIG. 2 depicts that no information was input to the input box at the timing of registering one record of the input relation log.

In the input candidate group storage means 102, input candidates for each type of information are stored in association with input candidates of each other type, respectively. In the exemplary embodiment, it is assumed that input candidates of each type are homogeneous data in terms of the type expression method. In other words, in the exemplary embodiment, it is assumed that input candidates of each type are data with the corresponding type expressed in the same style.

Although the contents and number of types to be held in the input candidate group storage means 102 are optional, it is preferred to contain a type of information desired by the system to be input to a target input box. For example, in the input candidate group storage means 102, information as input candidates for a type of information that tends to be generally input to an input box may be preregistered. An existing database, such as a database of information on persons who belong to an organization or a database of information on company's products, can also be used as the input candidate group storage means 102. Further, an input log acquired in another system can be used as input candidates of types different from input box to input box as input destinations thereof.

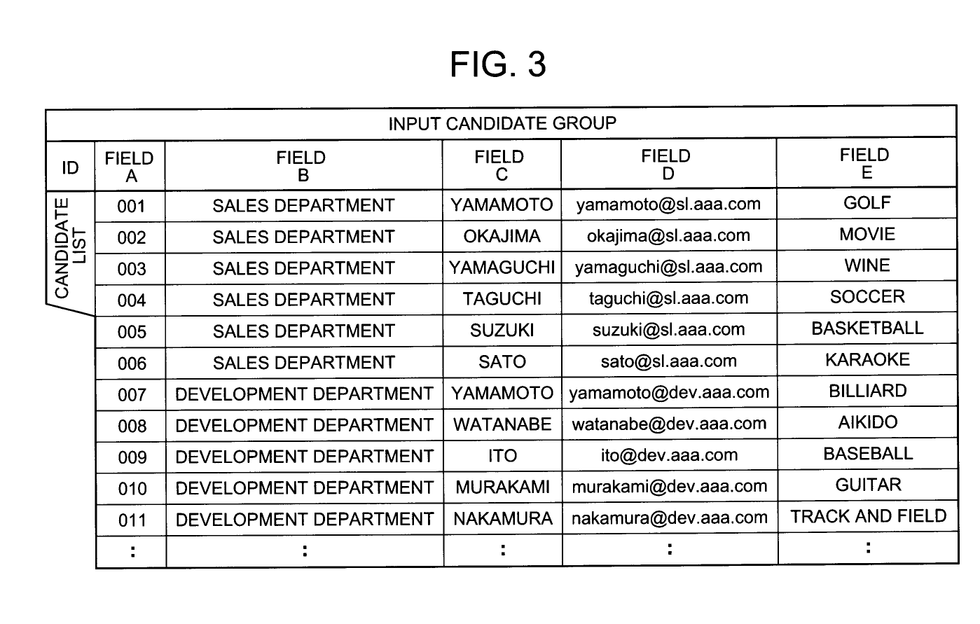

FIG. 3 is an explanatory diagram depicting an example of input candidate groups stored in the input candidate group storage means 102. FIG. 3 depicts an example of input candidate groups stored in the input candidate group storage means 102 having five type-specific fields given field names (identifiers) as “field A” to “field E.” In the example depicted in FIG. 3, an information group registered in the “field A” to the “field E” as one record is information on the same person. Thus, input candidates of respective types are stored in the input candidate group storage means 102 in association with one another.

The input type relation estimation means 103 estimates an input type relation between respective input boxes included in the multiple input boxes registered in the input relation log based on the input relation log stored in the input relation log storage means 101 and the input candidate groups stored in the input candidate group storage means 102. Note that the input relation log stored in the input relation log storage means 101 denotes an input log of multiple input boxes associated with one another. Further, each of the input candidate groups stored in the input candidate group storage means 102 denotes input candidates of each type associated with one another and a combination thereof. More specifically, the input candidates of each type and the combination thereof stored in the input candidate group storage means 102 mean a correspondence relation indicating that each input candidate of each type is associated with an input candidate of another type. Further, the input type relation between respective input boxes included in the multiple input boxes registered in the input relation log denotes a relation of types of input information between the respective input boxes included in the multiple input boxes. More specifically, the input type relation estimation means 103 estimates to which combination of fields of respective types (hereinafter called type-specific fields) stored in the input candidate group storage means 102 the relation of types of input information between respective input boxes included in the multiple input boxes registered in the input relation log corresponds. Here, the field means a set of information with a specific label attached and stored in the storage means, or a storage area storing the set of information. Note that the input type relation estimation means 103 does not have to identify what is the specific content of the type of input information in each input box as an estimation result of the input type relation between input boxes. Further, suppose that, as a result of the estimation, a certain input box is determined not to correspond to any of the type-specific fields stored in the input candidate group storage means 102, or that a correspondence relation between type-specific fields stored in the input candidate group storage means 102 is determined not to be found between certain input boxes. In these cases, the input type relation estimation means 103 may determine an input type relation between the input box and another input box or an input type relation between the input boxes to be unknown. Further, when three or more input boxes are specified, the input type relation estimation means 103 only has to perform the same processing on all pairs included in the specified input box groups to estimate an input type relation.

For example, the input type relation estimation means 103 may perform processing for estimating, from an input log of each input box stored in the input relation log storage means 101, to which type-specific field stored in the input candidate group storage means 102 the type of information to be input to the input box corresponds. Then, the input type relation estimation means 103 may estimate an input type relation between respective input boxes based on the estimation result and a correspondence relation of past input information between the respective input boxes in the input relation log.

For example, the input type relation estimation means 103 may calculate, for each input box, a matching degree of each type-specific field stored in the input candidate group storage means 102 with the input log of the input box, i.e., with the past input information. Then, the input type relation estimation means 103 may estimate, as a type-specific field corresponding to the type of information to be input to the input box, a type-specific field whose matching degree is larger than or equal to a predetermined threshold, or takes the largest value. For example, the input type relation estimation means 103 may determine, for each type-specific field stored in the input candidate group storage means 102, with which candidate registered in the type-specific field each piece of past input information stored as the input log matches. Then, the input type relation estimation means 103 may set, as the matching degree, a value quantified based on the number of input log records turned out to match as a result of the determination (hereinafter called the number of matched log records). For example, the number of matched log records for each type-specific field may be directly set as the matching degree. Further, for example, a ratio of the number of matched log records to the total number of input log records may be set as the matching degree.

Thus, the input type relation estimation means 103 may estimate to which type-specific field each input box corresponds. Based on the estimation result, for example, the input type relation estimation means 103 may refer to the input relation log between target input boxes to count how many records of input logs of the two input boxes in the registered input relation log have a relation corresponding to the relation between type-specific fields as each estimation result. Then, when the ratio is larger than or equal to a predetermined threshold value, the input type relation estimation means 103 may identify a combination of type-specific fields presented as a result of the estimation by the input type relation estimation means 103 as an input type relation between the input boxes. When the ratio is smaller than the predetermined threshold value, the input type relation estimation means 103 may determine that the input type relation between the input boxes is unknown.

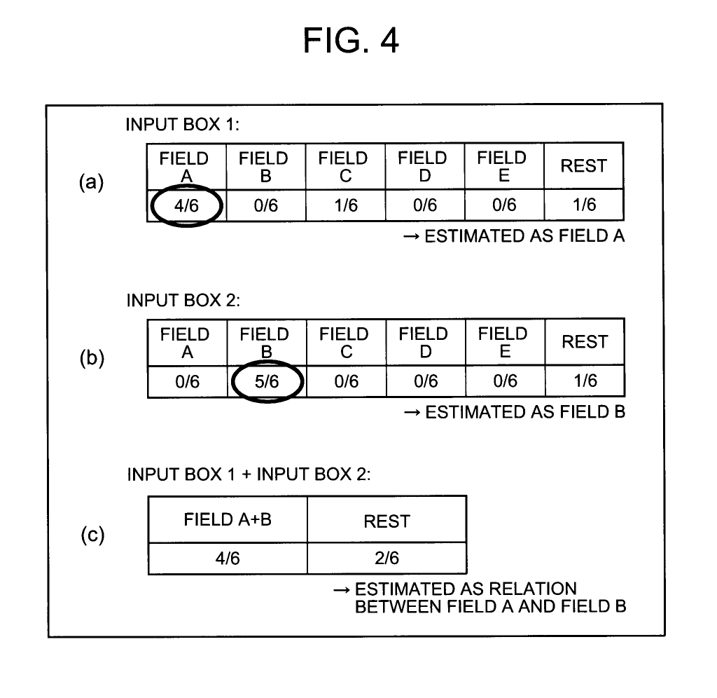

FIG. 4 is an explanatory diagram depicting an example in which the input type relation estimation means 103 estimates an input type relation between certain input boxes. The example depicted in FIG. 4 is an example when an input type relation between the input box 1 and the input box 2 is estimated based on the example of the input relation log depicted in FIG. 2 and the example of the input candidate groups depicted in FIG. 3. The input type relation estimation means 103 first estimates to which type-specific field the type of information to be input to each of the target input box 1 and input box 2 corresponds.

Specifically, the input type relation estimation means 103 identifies, for each target input box, to which candidate contained in the type-specific field the content of each record of the input log of the input box corresponds. Then, the input type relation estimation means 103 counts the number of matched log records for each type-specific field, and based on the result, calculates a matching degree. The input type relation estimation means 103 may use any of various methods to determine whether the content of each record of the input log matches each candidate contained in the type-specific field. For example, the input type relation estimation means 103 may handle each piece of information as character string information to make a determination based on whether both exactly match each other. Further, the input type relation estimation means 103 may make a determination based on whether the beginning of a candidate character string as the candidate content matches that of a past input character string as the content of a log record. In the case of a forward match, the input type relation estimation means 103 may make a determination based on whether the ratio of the number of matched characters in the past input character string to the number of characters in the candidate character string is a predetermined value or more, or the like.

Further, for example, the input type relation estimation means 103 may compare the past input character string and the candidate character string, and when the similarity between both character strings is predetermined value or more, determine that both match each other and add it to the number of matched log records. Note that the input type relation estimation means 103 may determine the similarity between the character strings by using edit distance, information distance vectorized using an n-gram, or the like. Further, the input type relation estimation means 103 may use a weighted distance to change the degree of importance depending on the character position such as to give a weight to matching between first character strings.

When one input character string is determined to match candidates in two or more type-specific fields, the input type relation estimation means 103 may count the number of matched log records for each field. Further, when the forward matching method or the like is used, the input type relation estimation means 103 may count, as the number of matched log records, matches in only a field with a larger ratio of the number of matched characters or with a closer distance indicative of the similarity between character strings.

FIG. 4(a) depicts one example of estimation processing for each type-specific field with respect to the input box 1. FIG. 4(a) depicts an example in which, among input log records of the input box 1, the input log records that match the candidates in the “field A” are 4 out of 6, the input log records that match the candidates in the “field B” are 0 out of 6, the input log records that match the candidates in the “field C” are 1 out of 6, the input log records that match the candidates in the “field D” are 0 out of 6, the input log records that match the candidates in the “field E” are 0 out of 6, and those in the “rest,” i.e., the input log records that do not match the candidates in any of the type-specific fields are 1 out of 6. From such an example, FIG. 4(a) depicts an example in which, as a result of calculating, as the matching degree, a matching ratio to the total number of input log records (six records in the example) based on each of these numbers of matched log records, the input type relation estimation means 103 estimates that the type-specific field corresponding to the input box 1 is the “field A.” Here, if the matching ratio in the “rest” takes the largest value, the input type relation estimation means 103 may set the estimation result as no corresponding field, i.e., type unknown.

FIG. 4(b) depicts one example of estimation processing for each type-specific field with respect to the input box 2. FIG. 4(b) depicts an example in which, among input log records of the input box 2, the input log records that match the candidates in the “field A” are 0 out of 6, the input log records that match the candidates in the “field B” are 5 out of 6, the input log records that match the candidates in the “field C” are 0 out of 6, the input log records that match the candidates in the “field D” are 0 out of 6, the input log records that match the candidates in the “field E” are 0 out of 6, and those in the “rest,” i.e., the input log records that do not match the candidates in any of the type-specific fields is 1 out of 6. From such an example, FIG. 4(b) depicts an example in which, as a result of calculating, as the matching degree, a matching ratio to the total number of input log records (six records in the example) based on each of these numbers of matched log records, the input type relation estimation means 103 estimates that the type-specific field corresponding to the input box 2 is the “field B.”

FIG. 4(c) depicts an example of estimating an input type relation between the input box 1 and the input box 2 based on the estimation results of the input box 1 and the input box 2 as mentioned above. For example, the input type relation estimation means 103 estimates an input type relation between the input box 1 and the input box 2 based on the estimation results of the types of input information of the input box 1 and the input box 2 as mentioned above, and a correspondence relation of input logs between the input boxes in the input relation log. For example, the input type relation estimation means 103 may refer to the input relation log between the input box 1 and the input box 2 to count how many records of input logs of the input box 1 and the input box 2 has a correspondence relation that becomes the relation between the “field A” and the “field B” as each estimation result. Then, when the ratio is larger than or equal to a predetermined threshold value, the input type relation estimation means 103 may determine the input type relation between the input box 1 and the input box 2 to be the relation between the “field A” and the “field B.” In the example depicted in FIG. 4(c), the records with the input log of the input box 1 matching the “field A” and the input log of the input box 2 matching the “field B” are 4 out of 6 in the input relation log between the input box 1 and the input box 2, and the matching ratio is more than 0.5. Therefore, the input type relation estimation means 103 estimates the input type relation between the input box 1 and the input box 2 as the relation between the “field A” and the “field B” in the input candidate group storage means 102. When determining a correspondence relation of input logs in the input relation log between the input box 1 and the input box 2, the input type relation estimation means 103 may further add, to the determination result, whether each content matches a combination of candidates associated as one record in the input candidate group storage means 102. In this case, the matched records in FIG. 4(c) are 3 out of 6.

Note that the input type relation estimation means 103 may also use any method other than the methods mentioned above to estimate the input type relation between input boxes. For example, based on the result of the matching determination between each input log of each input box, with which the input type relation is to be estimated, and the candidates of each type-specific field, the input type relation estimation means 103 may estimate, as the input type relation between the input boxes, a combination most common among the combinations of type-specific fields between the input boxes in the input relation log.

Further, in determining whether the input log matches the candidates of each type-specific field, the input type relation estimation means 103 may use a degree of similarity between texts or the like, rather than two values such as 1 and 0, to express whether they match. As the degree of similarity between texts, for example, a degree of similarity using edit distance, a degree of similarity after being vectorized using an n-gram, a degree of similarity vectorized after being subjected to morphological analysis or feature word extraction, and the like are cited. In other words, in counting the number of matched log records, the input type relation estimation means 103 may add the degree of similarity without determining whether they match or not, rather than add one when they match. Further, when a level of effectiveness is attached to each record of the input log, the input type relation estimation means 103 may handle the level of effectiveness as a weight. In other words, when handling the number of records or the degree of similarity, the input type relation estimation means 103 may perform processing for multiplying the levels of effectiveness of respective records together to take the sum, or the like. Such a log with levels of effectiveness can be obtained, for example, by waiting for the result of error determination of the input upon registration of the log to register the log together with the result.

In the exemplary embodiment, for example, the input relation log storage means 101 and the input candidate group storage means 102 are realized by storage devices such as databases. Further, for example, the input type relation estimation means 103 is implemented by an information processing apparatus operating according to a CPU program or the like. Note that the input support system itself may not necessarily include the input relation log storage means 101 and the input candidate group storage means 102 as long as the input type relation estimation means 103 is accessible thereto.

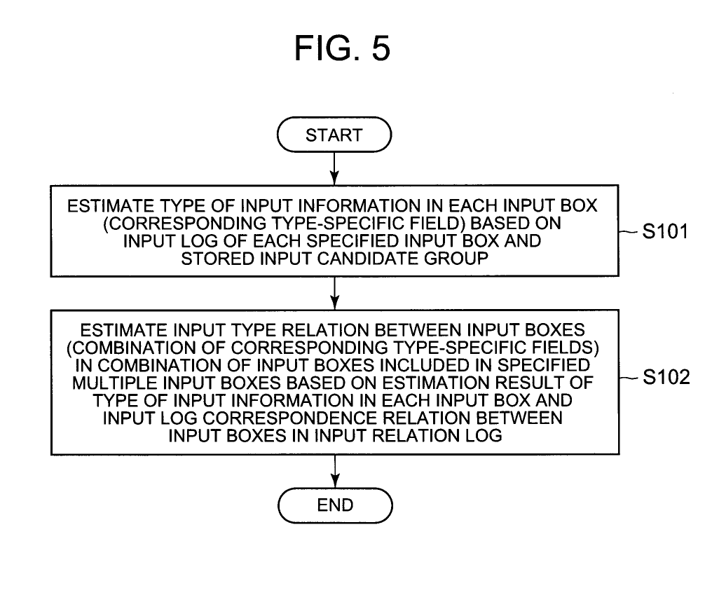

FIG. 5 is a flowchart depicting one example of operation of the exemplary embodiment. Note that FIG. 5 is a flowchart depicting, among the operations of the exemplary embodiment, an example of a processing flow of estimation processing for an input type relation between respective input boxes by the input type relation estimation means 103. As depicted in FIG. 5, for example, suppose that the estimation of an input type relation between input boxes in certain multiple input boxes is requested. In this case, the input type relation estimation means 103 may estimate, for each input box, to which type-specific field each type of information to be input to the input box corresponds based on an input log of the input box stored in the input relation log storage means 101 and a candidate group stored in the input candidate group storage means 102 (step S101). Next, based on the estimation result and a correspondence relation of input logs between the respective input boxes stored in the input relation log storage means 101, the input type relation estimation means 103 estimates to which combination of type-specific fields the input type relation between the respective input boxes corresponds (step S102). Such estimation processing for the input type relation between the respective input boxes may be, for example, performed in initialization processing at the time of introduction of the system, or performed periodically during the operation of the system.

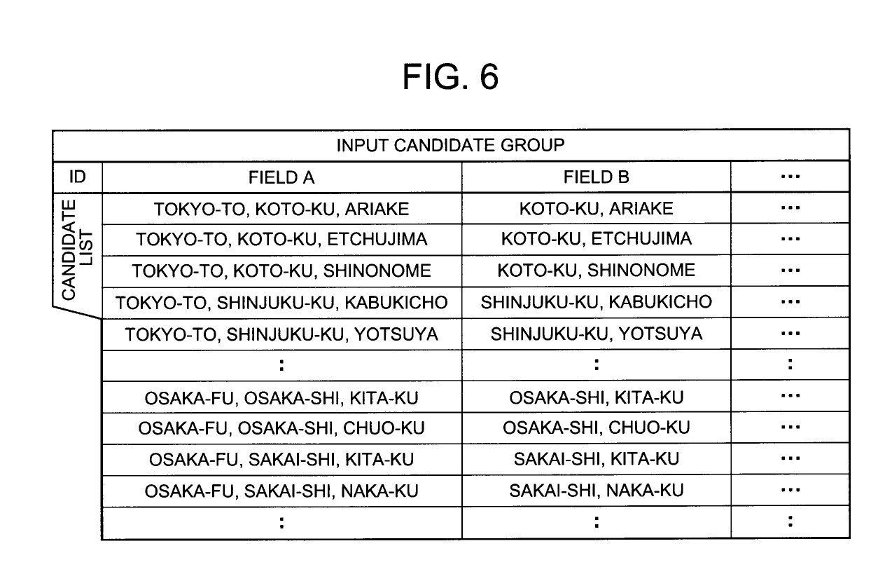

FIG. 6 is an explanatory diagram depicting another example of input candidate groups stored in the input candidate group storage means 102. As depicted in FIG. 6, the input candidate groups may be such that candidates that take multiple description formats for the same entry are registered as different types of candidates. Note that FIG. 6 depicts an example of input candidate groups registered in the input candidate group storage means 102 having a type-specific field given a field name as “field A” and a type-specific field given a field name as “field B” in such a manner that respective input candidates are associated with each other. In this example, input candidates representing “addresses” in both the “field A” and “field B” are registered. More specifically, a list of information candidates for information as “addresses starting with the name of a prefecture” is registered in the “field A,” and a list of candidates for information as “addresses that do not include the name of a prefecture” is registered in the “field B.”

Thus, even for the same entry, if multiple input candidates different in description format are registered as different types of input candidates, such a difference in description format can be discriminated to estimate to which type-specific field each input box corresponds. Therefore, even without specifying, in advance, the type of data that can be input, input of information whose description format is discriminated can be supported from the estimation result based on an input log and information input to any other corresponding input box.

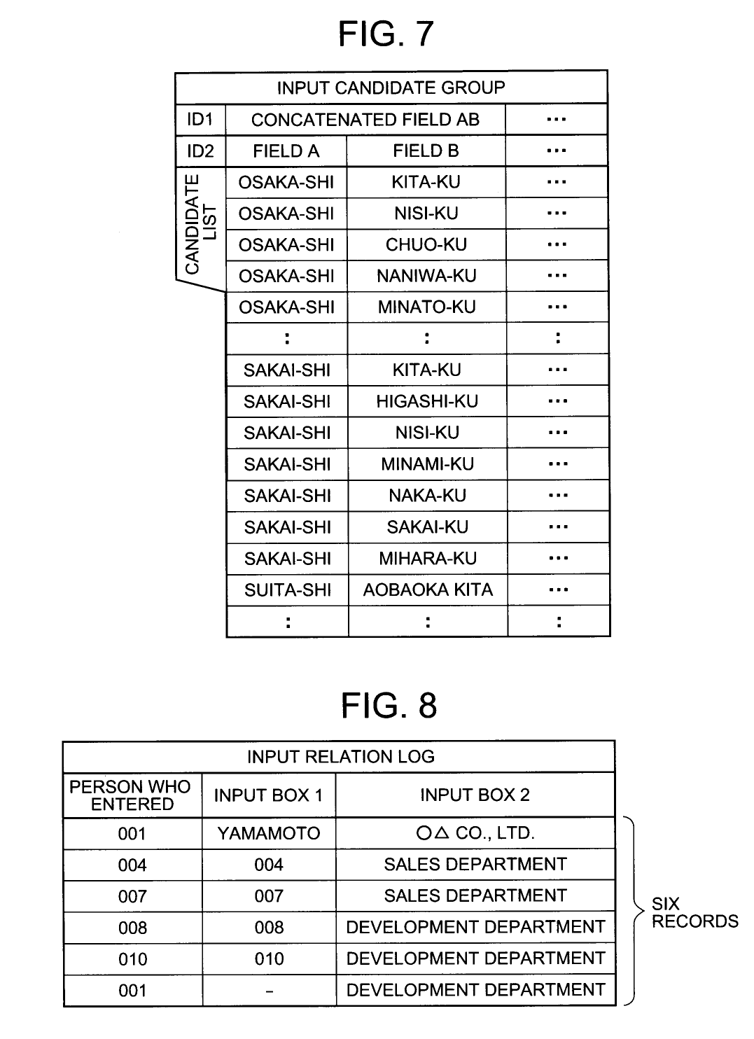

FIG. 7 is an explanatory diagram depicting still another example of an input candidate group stored in the input candidate group storage means 102. As depicted in FIG. 7, the input candidate groups may be such that type-specific fields with pieces of information different in granularity from each other are concatenated and registered as one type-specific field. In the example depicted in FIG. 7, pieces of information obtained by dividing predetermined information (information indicative of addresses in the example) are registered in the “field A” and the “field B” as input candidates, respectively. In the example, it is assumed that information in the “field A” is larger in granularity.

In such a case, the input type relation estimation means 103 may handle the concatenated field as one type-specific field to make a determination of matching with the input log of each input box. In the example depicted in FIG. 7, the input type relation estimation means 103 may use the classification of a type-specific field as “ID1,” rather than the classification of type-specific fields as “ID2.” Specifically, the input type relation estimation means 103 may handle information, obtained by combining respective records of information in the fields A and B, as each record of information in the concatenated field. In the case of the example, the input type relation estimation means 103 combines “Osaka-shi (Osaka city)” as a candidate registered in the first record of the field A and “Kita-ku (Kita ward)” as a candidate registered in the first record of the field B. Then, the input type relation estimation means 103 may handle combined “Osaka-shi, Kita-ku” as a candidate registered in the first record of the concatenated field, and compare it with each record of the input log.

Although only the “concatenated field AB” as the type-specific field in the classification of “ID1” is depicted in FIG. 7, it is assumed that the input candidate group storage means 102 has any type-specific field (including a concatenated field) other than the concatenated field AB.

FIG. 8 is an explanatory diagram depicting an example of an input relation log with information indicative of persons who entered data. Such an input log with information indicative of persons who entered data can be obtained, for example, by using an authentication system, in which a user ID or the like is entered upon system login, to register a log together with information for identifying a user currently logged in when the log is registered. For example, when an input relation log with information indicative of a person who entered data as depicted in FIG. 8 is stored, the input type relation estimation means 103 may perform user-specific processing such as to perform estimation processing using only the input log records of the same person who entered data as a person currently entering data.

As described above, according to the exemplary embodiment, the input type relation estimation means 103 estimates a relation of the types of input information between input boxes included in multiple input boxes based on information input to each target input box in the past, a correspondence relation thereof, and an input candidate group in the input candidate group storage means 102. Therefore, even if the type of data that can be input is not specified in detail for each input box in advance, such as what type of information is input, input support can be performed on a combination of various input boxes, such as to make an error determination of one input box based on input of the other input box or perform predictive conversion. Further, according to the exemplary embodiment, the input type relation estimation means 103 can dynamically derive the type of input information for each input box according to a combination of input candidate groups to be registered in the input candidate group storage means 102 and an input relation log to be stored without giving detailed specifications to each input box in advance. Therefore, a fine input support system can be easily introduced.

For example, according to the exemplary embodiment, the classification of types to be registered in the input candidate group storage means 102 can be controlled to make a fine determination of granularity as to which is easier to enter, an address in Tokyo or a commonly used address, even when both are the same address. This determination can increase the accuracy of predictive conversion or an error determination. Further, according to the exemplary embodiment, the type or granularity of information to be input to an input box can be changed depending on how to give an input log even when the system is in operation.

### Exemplary Embodiment 2

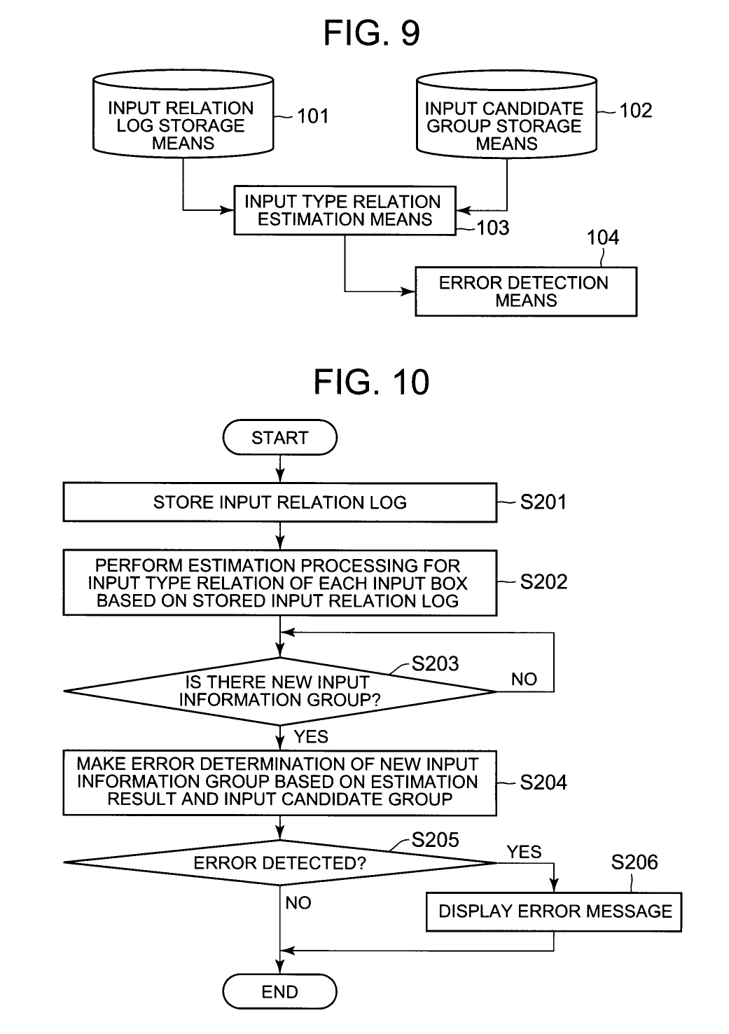

Next, a second exemplary embodiment of the present invention will be described. FIG. 9 is a block diagram depicting a configuration example of an input support system of the second exemplary embodiment. The input support system depicted in FIG. 9 is different from the first exemplary embodiment depicted in FIG. 1 in that error detection means 104 is newly provided.

When new input to a target input box group is done, the error detection means 104 makes an error determination based on an input type relation between respective input boxes included in the input box group as error detection targets estimated by the input type relation estimation means 103, and the input candidate groups (i.e., type-specific candidates and a combination thereof) stored in the input candidate group storage means 102. For example, the error detection means 104 may determine whether a combination of pieces of information input to the respective input boxes included in the target input box group matches a combination of candidates of type-specific fields corresponding to the respective input boxes to detect an error when they do not match.

In the exemplary embodiment, for example, the error detection means 104 is implemented by an information processing apparatus operating according to a CPU program or the like.

FIG. 10 is a flowchart depicting an example of operation of the input support system of the exemplary embodiment. In the exemplary embodiment, suppose that an input box group as an error detection target is specified in advance. Suppose next that an information group input in the past to each input box included in the input box group as an error detection target is put into one record and stored in the input relation log storage means 101 as an input relation log (step S201). Then, the input type relation estimation means 103 estimates an input type relation between respective input boxes included in the target input box group based on the input relation log stored in the input relation log storage means 101 and input candidate groups stored in the input candidate group storage means 102 (step S202). Here, it is assumed that at least information indicative of a pair of type-specific fields corresponding to types of input information between the respective input boxes is obtained as the estimation result.

Here, when new information is input to each input box included in the input box group as the error detection target (Yes in step S203), the error detection means 104 makes an error determination of a combination of pieces of input information input to respective input boxes based on the estimation result of an input type relation between the respective input boxes included in the input box group, and the input candidate groups stored in the input candidate group storage means 102 (step S204). When an error is detected (Yes in step S205), the error detection means 104 displays an error message (step S206).

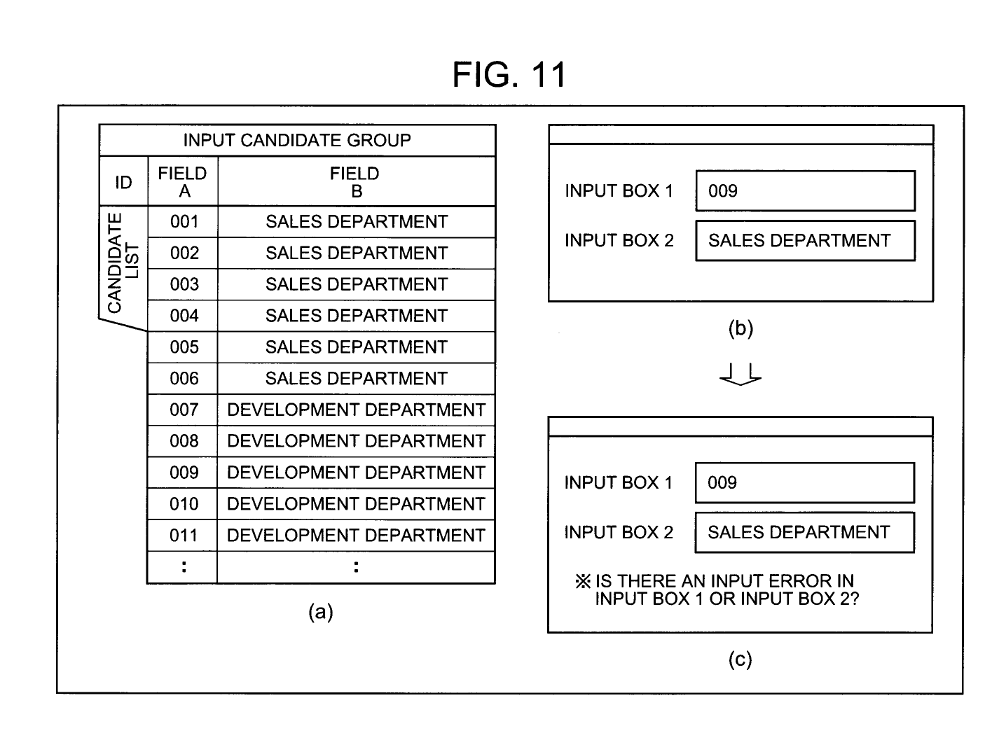

FIG. 11 is an explanatory diagram depicting an example of error detection processing by the error detection means 104. In the example, it is assumed that an input box 1 and an input box 2 in an input form depicted in FIG. 11(b) are specified as one of input box groups as an error detection target. It is also assumed that, as a result of estimation by the input type relation estimation means 103, the error detection means 104 has obtained information indicating that an input type relation between the input box 1 and the input box 2 has a relation between “field A” and “field B” in the input candidate group storage means 102 depicted in FIG. 11(a). In such a case, as depicted in FIG. 11(b), it is assumed that “009” is input to the input box 1 and “Sales Department” is input to the input box 2 as the input of new information. In such a case, the error detection means 104 may determine whether a combination that matches a pair of information pieces input to the respective input boxes included in the target input box group is included in the input candidate groups registered in the input candidate group storage means 102 to detect an error when no combination is included. In the example, although the pair of input information pieces are “009” and “Sales Department,” such a combination is not present in the combinations of candidates between the “field A” and the “field B” registered in the input candidate group storage means 102. Therefore, the error detection means 104 detects an error.

When an error is thus detected, the error detection means 104 may determine that there is an error in either the input to the input box 1 or the input to the input box 2 to display an error message for giving notice of that effect. For example, the error detection means 104 may output a message saying “Is there an input error in input box 1 or input box 2?” as depicted in FIG. 11(c).

Further, when displaying the error message, the error detection means 104 may output, as an erroneous input box, an input box having more types of information (a larger number of differences) in a list of candidates.

Further, when information that is not listed in the list of candidates is input in either of the input boxes, the error detection means 104 may determine the input box to be the erroneous input box to output an error message indicating that there is an error in the input to the input box.

Further, when a title (e.g., “Department Name” or the like) is given to a type-specific field, the error detection means 104 may use the title to output a message such as to say “Write a department name for 009.”

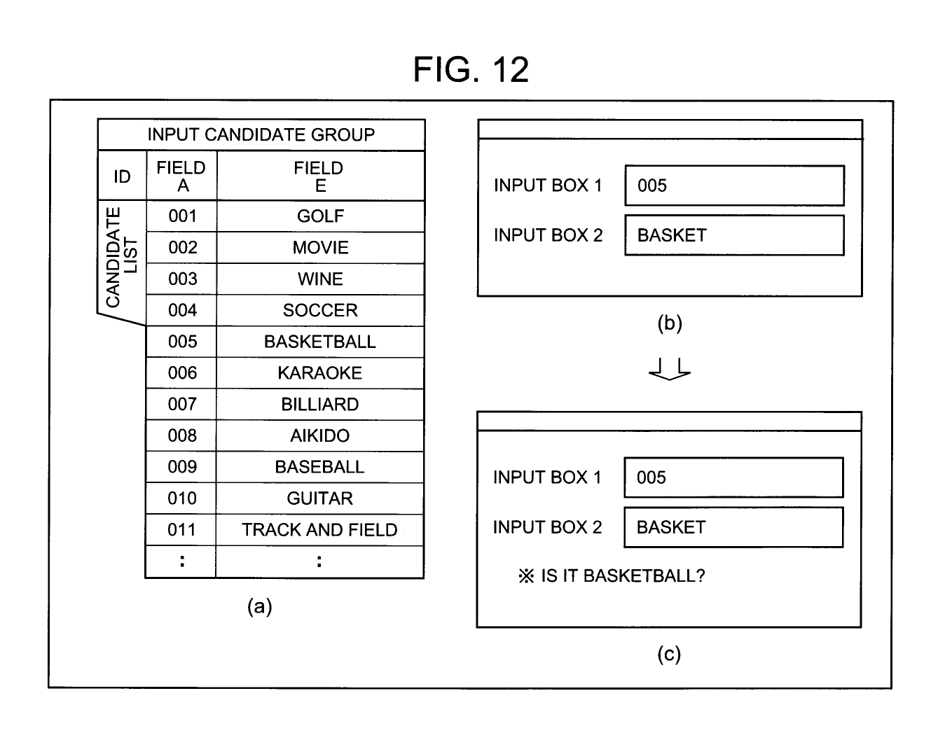

FIG. 12 is an explanatory diagram depicting another example of error detection processing by the error detection means 104. As depicted in FIG. 12, even when a combination that exactly matches a pair of information pieces input to the respective input boxes is not included in the combinations of candidates of the type-specific fields registered in the input candidate group storage means 102 and to which the respective input boxes correspond, if there is a combination of candidates having a partially matched character string or a combination of candidates having a character string whose similarity is a predetermined value or more, the error detection means 104 may regard the combination of candidates as correct answer candidates to output a message to make a user confirm the error while presenting the correct answer candidates. The example depicted in FIG. 12 is an example of error detection processing in a case where “009” is input to the input box 1 and “basket” is input to the input box 2 as the input of new information when information indicating that the input type relation between the input box 1 and the input box 2 is the relation between the “field A” and the “field E” of the input candidate group storage means 102 depicted in FIG. 12(a) has been obtained as a result of estimation by the input type relation estimation means 103 (see FIG. 12(b)). In such a case, the error detection means 104 may regard, as correct answer candidates, “009” and “basketball” obtained by combining type-specific candidates and having a similarity of a predetermined value or more to display a message saying “Is it basketball?” as depicted in FIG. 12(c).

FIG. 11 and FIG. 12 take two input boxes as an example. However, even when the number of input boxes is three or more, the error detection means 104 may determine, in the same manner, whether a combination that matches a combination of input information pieces input to respective input boxes is included in the input candidate groups registered in the input candidate group storage means 102 to detect an error if the combination is not included. When an error is detected in the case where the number of input boxes is three or more, the error detection means 104 may compare the combination of input information pieces with a combination of candidates that most matches the combination. Then, the error detection means 104 may determine an input box having input information that does not match any candidate to be an erroneous input box, and output an error message indicating that there is an error in input to the input box.

As described above, according to the exemplary embodiment, the error detection means 104 makes an error determination using the estimation result by the input type relation estimation means 103 and input candidate groups (i.e., a list of type-specific candidates and a combination thereof) stored in the input candidate group storage means 102. Therefore, even if the type of data that can be input is not specified in advance or the information has been input for the first time, it can be determined whether the input information is correct or not.

### Exemplary Embodiment 3

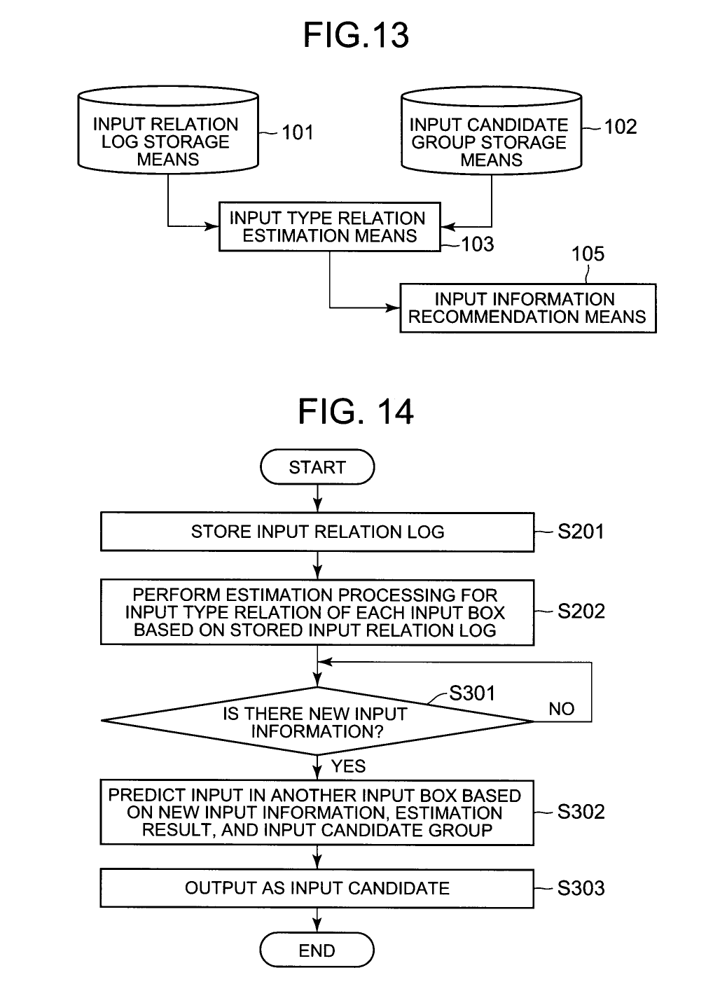

Next, a third exemplary embodiment of the present invention will be described. FIG. 13 is a block diagram depicting a configuration example of an input support system of the third exemplary embodiment. The input support system depicted in FIG. 13 is different from the first exemplary embodiment depicted in FIG. 1 in that input information recommendation means 105 is newly provided.

The input information recommendation means 105 determines whether there is new input to at least one input box included in an input box group as a target to recommend an input candidate. When there is such input, the input information recommendation means 105 estimates information to be input to another input box included in an input box group and presents it to a user as an input candidate based on an input type relation between respective input boxes in the input box group estimated by the input type relation estimation means 103, and the input candidate groups (i.e., type-specific candidates and a combination thereof) stored in the input candidate group storage means 102. Thus, in the exemplary embodiment, the input candidate group in the input candidate group storage means 102 is used as conversion knowledge between types to estimate an input candidate.

In the exemplary embodiment, for example, the input information recommendation means 105 is implemented by an information processing apparatus operating according to a CPU program or the like.

FIG. 14 is a flowchart depicting an example of operation of the input support system of the exemplary embodiment. Since step S201 and S202 in FIG. 14 are the same as in the second exemplary embodiment depicted in FIG. 10, the description thereof will be omitted below.

In the exemplary embodiment, suppose that a target input box group for which an input candidate is recommended is specified in advance. Suppose next that an information group input in the past to each input box included in the input box group as a target to recommend an input candidate is put into one record and stored in the input relation log storage means 101 as an input relation log.

In step S301, when new input to at least one input box included in the input box group as a target to recommend an input candidate is done (Yes in step S301), the input information recommendation means 105 estimates information to be input to another input box included in the input box group based on the input information, the estimation result of an input type relation between respective input boxes included in the input box group, and input candidate groups stored in the input candidate group storage means 102 (step S302). Then, the input information recommendation means 105 outputs the result as an input candidate (step S303).

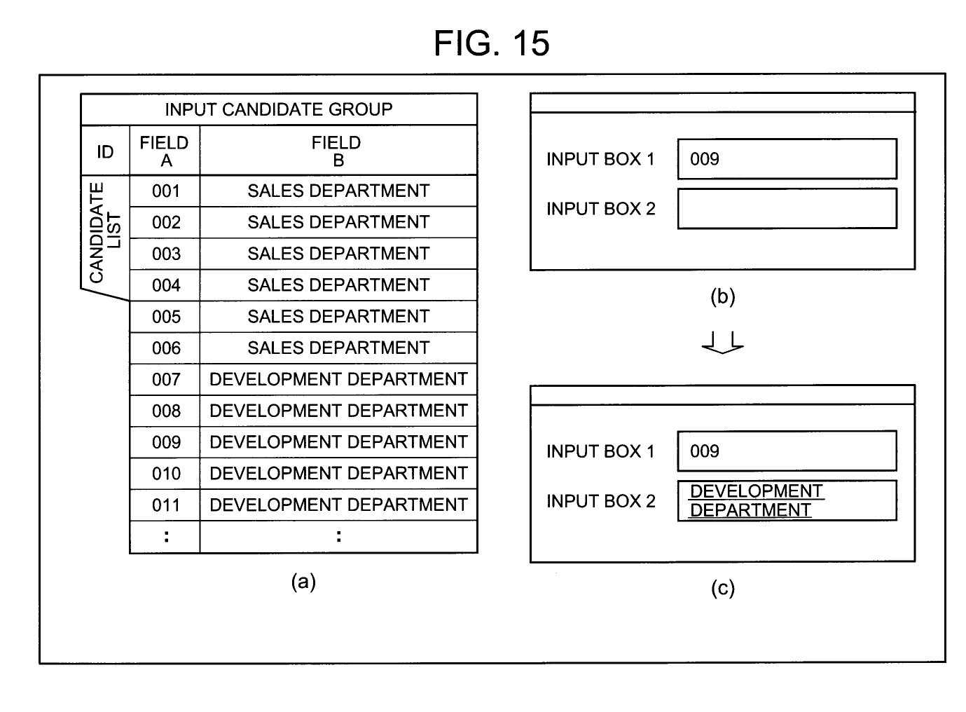

FIG. 15 is an explanatory diagram depicting an example of prediction processing by the input information recommendation means 105. In the example, it is assumed that input box 1 and input box 2 in an input form depicted in FIG. 15(b) are specified as one of target input box groups for which an input candidate is to be recommended. It is also assumed that, as a result of estimation by the input type relation estimation means 103, the input information recommendation means 105 has obtained information indicating that an input type relation between the input box 1 and the input box 2 has a relation between “field A” and “field B” in the input candidate group storage means 102 depicted in FIG. 15(a). In such a case, as depicted in FIG. 15(b), it is assumed that “009” is input to the input box 1 as the input of new information. In such a case, the input information recommendation means 105 searches for a record including a candidate that matches the input information from the candidates of a type-specific field corresponding to the input box with the information input thereto. Then, the input information recommendation means 105 may acquire, as an input candidate for another input box, a candidate of a type-specific field corresponding to the other input box associated with the candidate in the record. In the case of the example, the input information recommendation means 105 searches for a record including a candidate that matches “009” as the input information from the candidates registered in the “field A.” The input information recommendation means 105 may acquire, ad an input candidate for the input box 2, “Development Department” as a candidate of the “field B” associated with the candidate “009” in the record.

For example, the input information recommendation means 105 may display a potential character string directly into the input box to present the input candidate. At this time, for example, the input information recommendation means 105 may make the display form of recommended information different from that of user input information to discriminate between information (user input information) entered by a user and the input candidate (recommended information) presented by the input information recommendation means 105. For example, the input information recommendation means 105 may display the recommended information in a font lighter than the user input information. In the example depicted in FIG. 15(c), the recommended information is underlined to make a distinction. This can lead to discriminating between the user input information and the recommended information. Alternatively, for example, when an input operation to the input box becomes active as a result of clicking on the input form of the input box, or the like, the input information recommendation means 105 may display a list of recommended information in the form of a combo box or the like. Here, when there are multiple input candidates, the input information recommendation means 105 may display the input candidates in descending order of appearance frequency in the input candidate group or the input log. Further, for example, suppose that there are three or more input boxes for which information is to be recommended. In this case, after input to one input box is done, even if there are multiple candidates for another input box, a combination of candidates that matches a combination of information groups already input may be narrowed down by a user selecting information input to or a candidate for still another input box. In such a case, each time the user enters new information or selects a candidate, the input information recommendation means 105 may make a search again for a combination of candidates that matches a combination of information groups already input to dynamically narrow down the combination of candidates that matches the combination already input.

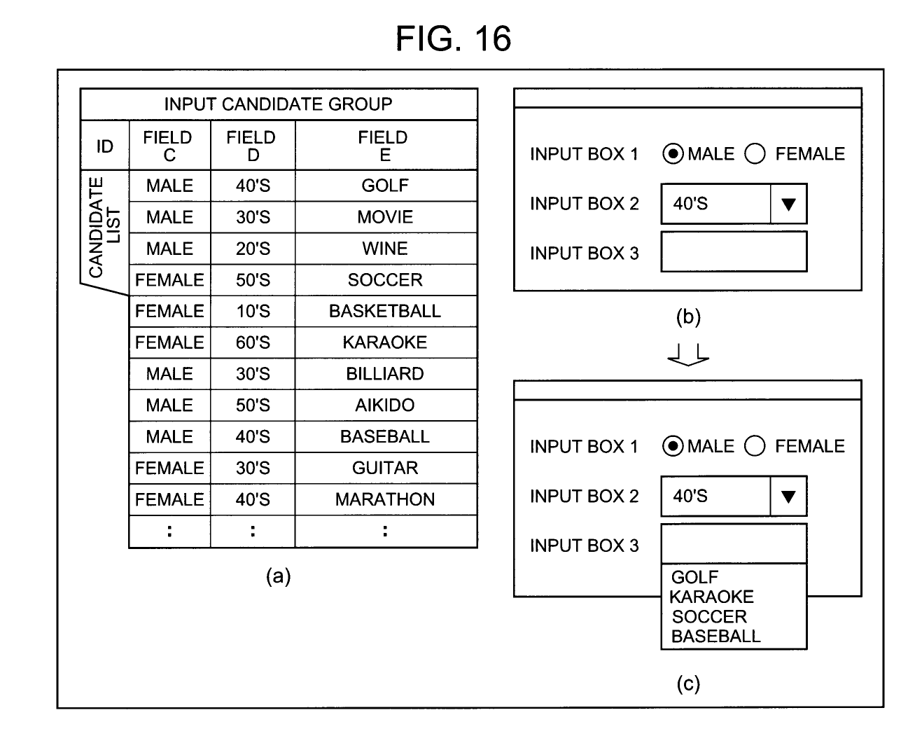

FIG. 16 is an explanatory diagram depicting another example of prediction processing by the input information recommendation means 105. In this example, it is assumed that input box 1, input box 2, and input box 3 in an input form depicted in FIG. 16(b) are specified as one of target input box groups for which input candidates are to be recommended. It is also assumed that the input information recommendation means 105 has obtained information indicating that an input type relation among the input box 1, the input box 2, and the input box 3 has a relation among “field C,” “field D,” and “field E” of the input candidate group storage means 102 depicted in FIG. 16(a) as a result of estimation by input type relation estimation means 103. In such a case, as depicted in FIG. 16(b), it is assumed that “Male” is input to the input box 1 and “40's” is input in the input box 2 as input of new information.

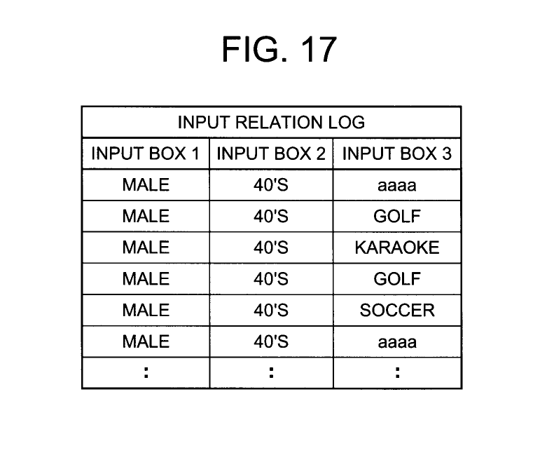

FIG. 17 is an explanatory diagram depicting an example of an input relation log at this time. In such a case, for example, the input information recommendation means 105 may search the input relation log for records that match the combination of input information in the input box 1 and the input box 2 to recommend data for the input box 3 included in searched records in descending order of appearance frequency. At this time, if data in the input box 3 are included as a candidate in a corresponding type-specific field inside the input candidate group storage means 102, the input information recommendation means 105 may perform processing for giving priority thereto, or the like. For example, the input information recommendation means 105 may create ranking based on a value obtained by multiplying a frequency included in each input candidate and a frequency included in the input relation log together. Alternatively, the input information recommendation means 105 may create ranking to give higher priority to any of them. In this case, the input information recommendation means 105 may add a level of effectiveness attached to the input log.

In the above example, although the example of searching for a combination in which both the input box 1 and the input box 2 match to extract input candidates is depicted, if at least one piece of input information matches, the input information recommendation means 105 may extract the record as candidates for target data. In this case, the input information recommendation means 105 may create ranking by using the frequency of data in the input box 3 with which each of the input box 1 and the input box 2 matches.

Further, when there is no data corresponding to the input relation log as a result of prediction processing based on such an input relation log, the input information recommendation means 105 may perform similar extraction processing on the input candidate group in the input candidate group storage means 102. Even when there are data corresponding to the input relation log, the input information recommendation means 105 may add the input candidate group in the input candidate group storage means 102 to the target to perform extraction processing on input candidates.

The above description is made by using the example in which there are three input boxes, but a combination of the prediction processing based on the input relation log and the prediction processing based on the input candidate group can also be applied to a case where the number of input boxes is 2. Further, such a condition as to whether the prediction processing based on the input relation log is performed regardless of the number of input boxes, which is prioritized, the input candidate group or the input relation log, when the prediction processing based on the input relation log is performed, how much priority is to be given to the input candidate group and the input relation log, or the like may be so set that the condition can be switched to another.

Further, as depicted in FIG. 16, the input boxes in the system are not limited to those to enter text, and they may be components for selective input such as a radio button, a combo box, and a check box.

FIG. 16(c) depicts an example of displaying a list of input candidates in this example. In the example depicted in FIG. 16(c), input information as “aaaa” of the input box 3 included in the input relation log is excluded on the grounds that the input information is not included in the list of candidates, but it may be added as one of the candidates, rather than being executed.

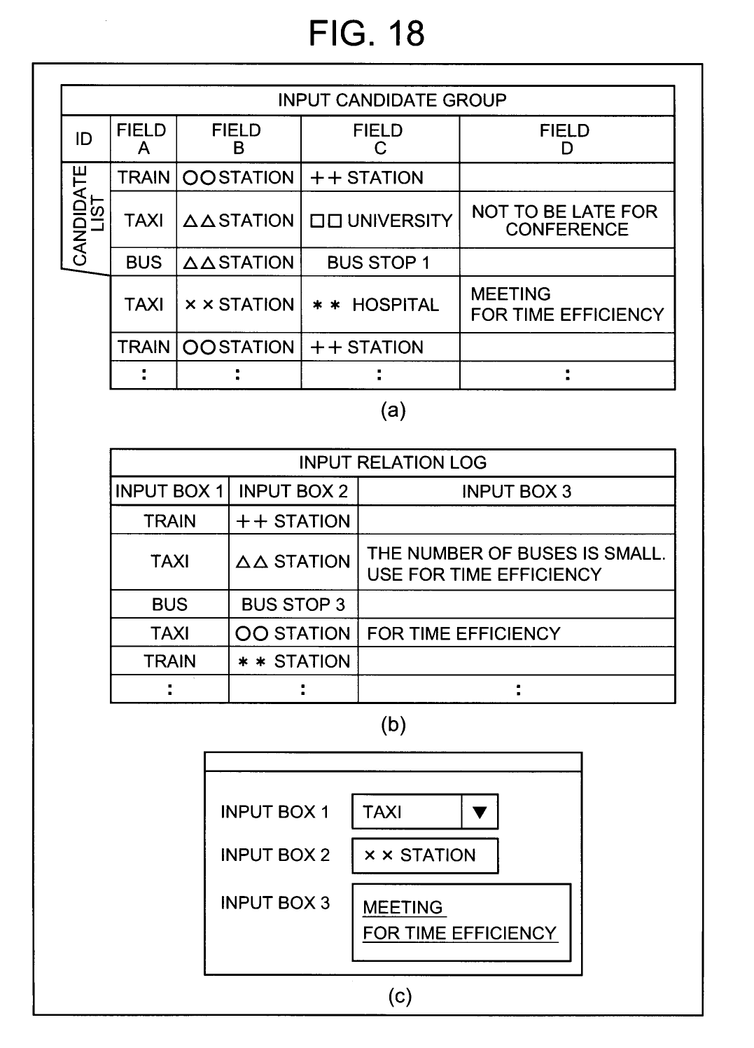

FIG. 18 is an explanatory diagram depicting still another example of prediction processing by the input information recommendation means 105. In this example, it is assumed that input box 1, input box 2, and input box 3 in an input form depicted in FIG. 18(c) are specified as one of target input box groups for which input candidates are to be recommended. It is also assumed that the input information recommendation means 105 has obtained information indicating that an input type relation among the input box 1, the input box 2, and the input box 3 has a relation among “field A,” “field B,” and “field D” of the input candidate group storage means 102 depicted in FIG. 18(a) as a result of estimation by input type relation estimation means 103. FIG. 18(b) is an example of the input relation log at this time. In such a case, as depicted in FIG. 18(c), it is assumed that “taxi” is input to the input box 1 and “xx station” is input to the input box 2 as the input of new information.

In such a case, for example, the input information recommendation means 105 may determine no record as a result of searching for records that match the pair of input information input from the input relation log to the input box 1 and the input box 2, and make a further search the input candidate groups in the input candidate group storage means 102 as search targets to search for records that match the pair of input information pieces input in the input box 1 and the input box 2. As a result, in this example, data stating “Meeting. For time efficiency” can be obtained as an input candidate for the input box 3. The input candidate may be text as in the example.

As described above, according to the exemplary embodiment, the estimation result by the input type relation estimation means 103 and input candidate groups (i.e., a list of type-specific candidates and a combination thereof) stored in the input candidate group storage means 102 can be used to estimate an input candidate for another input box. Therefore, even if the type of data that can be input to each input box is not specified in advance or the information has been input for the first time, an input candidate for a corresponding input box can be presented.

In the example depicted in FIG. 13, the input information recommendation means 105 is added to the configuration of the first exemplary embodiment. However, for example, the input information recommendation means 105 may be added to the configuration of the second exemplary embodiment. In such a case, error detection and presentation of a predictive conversion candidate may be performed at the same time, or only either one of the functions may be selectively performed.

Further, in each of the aforementioned exemplary embodiments, output means for displaying a screen including an input box(s) in which input from a user is accepted, and input means for accepting input to the input box by the user are not illustrated. These input and output means are, for example, realized by a display device, a keyboard, a touch panel, and the like. Further, a relationship between these input and output means, and other processing means may be realized in a server/client system like a web system, or by a single apparatus (stand-along system).

While the present invention has been described with reference to the aforementioned exemplary embodiments and examples, the present invention is not limited to the aforementioned exemplary embodiments and examples. Various changes that can be understood by those skilled in the art within the scope of the present invention can be made to the configurations and details of the present invention.

This application is based upon and claims the benefit of priority from Japanese patent application No. 2013-009572, filed on Jan. 22, 2013, the disclosure of which is incorporated herein in its entirety by reference.

### INDUSTRIAL APPLICABILITY

The present invention can be suitably applied to a system in which various input boxes are provided on a user interface.

### REFERENCE SIGNS LIST

101 input relation log storage means
102 input candidate group storage means
103 input type relation estimation means
104 error detection means
105 input information recommendation means

What is claimed is:

1. An input support system for supporting input to a plurality of input boxes, comprising:
an input relation log storage unit which stores, as an input relation log, pieces of information input to the plurality of input boxes in the past in association with one another;
an input candidate group storage unit which stores an input candidate for each type of information in association with an input candidate of each other type; and
an input type relation estimation unit which estimates to which combination of type-specific fields, as fields for respective types stored in the input candidate group storage unit, a relation of types of input information between respective input boxes included in the plurality of input boxes corresponds, based on the input relation log stored in the input relation log storage unit, and type-specific input candidates and a combination thereof stored in the input candidate group storage unit.

2. The input support system according to claim 1, further comprising
an error detection unit which makes an error determination of information input to each input box included in the plurality of input boxes to detect an error based on the estimation result by the input type relation estimation unit, and type-specific input candidates and a combination thereof stored in the input candidate group storage unit.

3. The input support system according to claim 2, wherein the error detection unit determines whether a combination of pieces of information input to each input box included in the plurality of input boxes matches a combination of input candidates of a type-specific field which corresponds to the input box and is stored in the input candidate group storage unit, and if not match, detects an error.

4. The input support system according to claim 1, further comprising an input information recommendation unit which, when information is input to at least one input box included in the plurality of input boxes, estimates information to be input to another input box included in the plurality of input boxes and outputs the information as an input candidate based on the estimation result by the input type relation estimation unit, and the type-specific input candidates and the combination thereof stored in the input candidate group storage unit.

5. The input support system according to claim 4, wherein the input information recommendation unit searches for an input candidate that matches the input information from input candidates of a type-specific field corresponding to the input box to which the information is input, acquires an input candidate of a type-specific field corresponding to another input box associated with the searched input candidate, and outputs the acquired input candidate as an input candidate for information to be input to the other input box.

6. The input support system according to claim 1, wherein the input type relation estimation unit compares, for each of the plurality of input boxes stored in the input relation log storage unit, information input to the input box in the past and type-specific input candidates stored in the input candidate group storage unit, estimates to which type-specific field stored in the input candidate group storage unit a type of input information of the input box corresponds, and based on the estimation result and a correspondence relation of information input in the past between respective input boxes in the input relation log stored in the input relation log storage unit, estimates to which combination of type-specific fields stored in the input candidate group storage unit a relation of types of input information between the respective input boxes included in the plurality of input boxes corresponds.

7. The input support system according to claim 1, wherein the input type relation estimation unit compares information input in the past to each input box of the plurality of input boxes stored in the input relation log storage unit and type-specific input candidates stored in the input candidate group storage unit, estimates to which type-specific field stored in the input candidate group storage unit the information input in the past to the input box corresponds, and based on a correspondence relation of types of information indicated by the estimation result to be input in the past between respective input boxes in the input relation log stored in the input relation log storage unit, estimates to which combination of type-specific fields stored in the input candidate group storage unit the relation of types of input information between the respective input boxes included in the plurality of input boxes corresponds.

8. An input support method for supporting input to a plurality of input boxes, comprising:
causing an input relation log storage unit to store, as an input relation log, pieces of information input to the plurality of input boxes in the past in association with one another;
causing an input candidate group storage unit to store an input candidate for each type of information in association with an input candidate of each other type;
causing an input type relation estimation unit to estimate to which combination of type-specific fields, as fields for respective types stored in the input candidate group storage unit, a relation of types of input information between respective input boxes included in the plurality of input boxes corresponds, based on the input relation log stored in the input relation log storage
unit, and type-specific input candidates and a combination thereof stored in the input candidate group storage unit; and
causing error detection unit or input information recommendation unit to make an error determination of information input to the plurality of input boxes or predict information to be input thereto based on the estimation result by the input type relation estimation unit and type-specific input candidates and a combination thereof stored in the input candidate group storage unit.

9. The input support method according to claim 8, wherein the error detection unit determines whether a combination of pieces of information input to each input box included in the plurality of input boxes matches a combination of input candidates of a type-specific field which corresponds to the input box and is stored in the input candidate group storage unit, and if not match, detects an error.

10. The input support method according to claim 8, wherein the input information recommendation unit searches for an input candidate that matches the input information from input candidates of a type-specific field corresponding to the input box to which the information is input among the plurality of input boxes, acquires an input candidate of a type-specific field corresponding to another input box associated with the searched input candidate, and outputs the acquired input
candidate as the estimation result of information to be input to the other input box.

11. A non-transitory computer readable information recording medium storing an input support program applied to a computer accessible to an input relation log storage unit for storing pieces of information input in the past to a plurality of input boxes in association with one another, and an input candidate group storage unit for storing an input candidate for each type of information in association with an input candidate of each other type, when executed by a processor, the program performs a method for:
estimating to which combination of type-specific fields, as fields for respective types stored in the input candidate group storage unit, a relation of types of input information between respective input boxes included in the plurality of input boxes corresponds, based on the input relation log stored in the input relation log storage unit, and type-specific input candidates and a combination thereof stored in the input candidate group storage unit.

12. The non-transitory computer readable information recording medium according to claim 11, further comprising: making an error determination of information input to the plurality of input boxes or predict information to be input thereto based on the
estimation result, and the type-specific input candidates and the combination thereof stored in the input candidate group storage unit.
